(19) United States
(12) Patent Application Publication
(10) Pub. No.: US 2020/0218183 A1
(43) Pub. Date: Jul. 9, 2020

(54) FIXING DEVICE, IMAGE FORMING APPARATUS, CONTROL METHOD, AND COMPUTER PROGRAM

(71) Applicant: Konica Minolta Inc., Tokyo (JP)

(72) Inventor: Takuto SHIBUYA, Okazaki-shi (JP)

(21) Appl. No.: 16/713,912

(22) Filed: Dec. 13, 2019

(30) Foreign Application Priority Data
Jan. 9, 2019 (JP) 2019-002008

(51) Int. Cl. G03G 15/20

(52) U.S. Cl. CPC G03G 15/2039

(57) ABSTRACT

A fixing device includes: an endless fixing belt; a heat source that is disposed on an inner circumferential side of the fixing belt and is capable of adjusting an amount of heat generation with supplied electric power; a pressure receiver disposed on the inner circumferential side of the fixing belt; a pressure applier that presses the pressure receiver, to form a fixing nip with the fixing belt; a temperature detector that detects a temperature of an outer circumferential surface of the fixing belt in the heat source; a controller that controls power supply to the heat source, to adjust a detected temperature to be detected by the temperature detector to a target temperature; a temperature difference detector that detects a temperature difference between an inner circumferential surface and the outer circumferential surface of the fixing belt; and a corrector that corrects the target temperature of the controller.

The entire disclosure of Japanese patent Application No. 2019-002008, filed on Jan. 9, 2019, is incorporated herein by reference in its entirety.

### BACKGROUND

### Technological Field

The present invention relates to a technology for controlling the fixing temperature in a fixing device included in an electrophotographic image forming apparatus.

### Description of the Related Art

In a conventional fixing device, energization to the fixing heater is controlled so that the temperature of the fixing member becomes equal to the target temperature.

According to JP 2011-164264 A, in a fixing device, a pressure roller is in contact with the outer circumferential surface of a fixing sleeve formed with an endless belt, and a contact member disposed on the inner circumferential side of the fixing sleeve is in contact with the pressure roller via the fixing sleeve, to form a nip portion. A planar heating element that heats the fixing sleeve is disposed in contact with the inner circumferential surface of the fixing sleeve. Further, a temperature sensor that detects the temperature of the outer circumferential surface of the fixing sleeve is disposed on the opposite side from the nip portion at the middle portion in the axial direction of the fixing sleeve.

### CITATION LIST

### Patent Literature

Patent Literature 1: JP 2011-164264 A

Patent Literature 2: JP 2006-106630 A

By the technique disclosed in JP 2011-164264 A, however, the temperature of the outer circumferential surface of the fixing sleeve at a position away from the nip portion is detected, and there are cases where the temperature difference between the temperature detected by the temperature sensor and the temperature of the outer circumferential surface of the fixing sleeve at the nip portion varies depending on the amount of heat supplied from the planar heating element as the heat source to the fixing sleeve. That is, even in a case where the same temperature is detected by the temperature sensor, the temperature at the nip portion might be different. For this reason, even if the amount of heat to be supplied from the planar heating element is controlled so that the temperature detected by the temperature sensor becomes equal to the target temperature, the temperature at the nip portion does not necessarily become constant, and the amount of heat to be applied to a sheet might be excessive or insufficient.

### SUMMARY

To solve the above problem, an embodiment of the present invention aims to provide a fixing device, an image forming apparatus, a control method, and a computer program that are capable of applying an appropriate amount of heat to a sheet.

To achieve the abovementioned object, according to an aspect of the present invention, there is provided a fixing device that thermally fixes a toner image formed on a sheet, and the fixing device reflecting one aspect of the present invention comprises: an endless fixing belt; a heat source that is disposed on an inner circumferential side of the fixing belt and is capable of adjusting an amount of heat generation with supplied electric power; a pressure receiver disposed on the inner circumferential side of the fixing belt; a pressure applier that presses the pressure receiver, to form a fixing nip with the fixing belt; a temperature detector that detects a temperature of an outer circumferential surface of the fixing belt in the heat source; a controller that controls power supply to the heat source, to adjust a detected temperature to be detected by the temperature detector to a target temperature; a temperature difference detector that detects a temperature difference between an inner circumferential surface and the outer circumferential surface of the fixing belt; and a corrector that corrects the target temperature of the controller, on a basis of the temperature difference detected by the temperature difference detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically showing the configuration of an image forming apparatus according to an embodiment;

FIG. 2 is a schematic cross-sectional diagram showing a schematic cross-section of a fixing unit;

FIG. 3 is a conceptual diagram showing how heat is transmitted in a fixing belt in respective cases where a portion of the fixing belt has reached a position in the vicinity of a fixing heater, where the portion has reached a position between the vicinity of the fixing heater and a fixing nip, and where the portion has reached a position immediately before the fixing nip;

FIG. 4 is a graph showing a temperature change in the thickness direction in the fixing belt;

FIG. 5 is a graph showing changes in the temperatures of the inner circumferential surface and the outer circumferential surface of the fixing belt in the respective cases where a portion of the fixing belt has reached a position in the vicinity of the fixing heater, where the portion has reached a position between the vicinity of the fixing heater and the fixing nip, and where the portion has reached the position immediately before the fixing nip;

FIG. 6 is a graph showing temporal changes in the target temperature, the sensor detected temperature, and the intended temperature immediately before the fixing nip in a case where the turn-on DUTY of the fixing heater is low;

FIG. 7 is a graph showing temporal changes in the target temperature, the sensor detected temperature, and the intended temperature immediately before the fixing nip in a case where the turn-on DUTY of the fixing heater is high;

FIG. 8 is a block diagram showing the configuration of a main control unit and the like;

FIG. 9 is a diagram showing the data structure of a temperature difference table;

FIG. 10 is a diagram showing the data structure of a correction amount table;

FIG. 11 is a graph showing a temperature difference function;

FIG. 12 is a graph schematically showing a correction function;

FIG. 13 is a flowchart showing operations in a printer control unit and a fixing device control unit;

FIG. 14 is a graph showing temporal changes in the target temperature, the intended temperature immediately before the fixing nip, the sensor detected temperature, and the temperature immediately before the fixing nip;

FIG. 15 is a schematic cross-sectional diagram showing a schematic cross-section of a fixing unit of a first modification;

FIG. 16 is a diagram showing the data structure of a temperature difference table of the first modification;

FIG. 17 is a graph showing a temperature difference in the first modification;

FIG. 18 is a flowchart showing an operation in the first modification;

FIG. 19 is a schematic cross-sectional diagram showing a schematic cross-section of a fixing unit of a second modification;

FIG. 20 is a diagram showing the data structure of a temperature difference table of the second modification; and

FIG. 21 is a flowchart showing an operation in the second modification.

### DETAILED DESCRIPTION OF EMBODIMENTS

Hereinafter, an image forming apparatus 10 as one or more embodiments of the present invention will be described with reference to the drawings. However, the scope of the invention is not limited to the disclosed embodiments.

### 1. Embodiment

### 1.1. Image Forming Apparatus 10

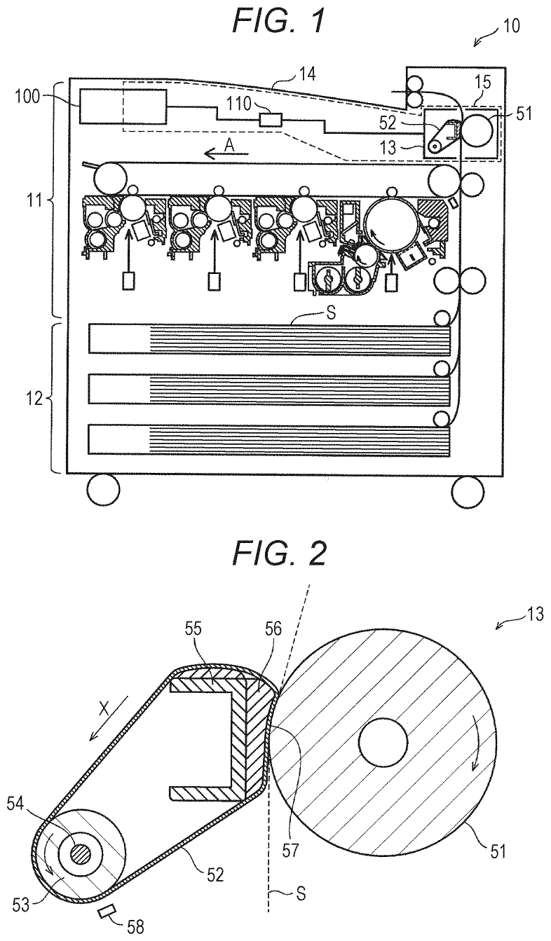

As shown in FIG. 1, the image forming apparatus 10 is a so-called tandem color printer apparatus. The image forming apparatus 10 receives a print job from an external terminal device such as a personal computer (PC), and forms an image on a recording sheet by an electrophotographic technique in accordance with the received print job.

In the image forming apparatus 10, a sheet feeder device 12 that stores and feeds recording sheets is disposed at a bottom portion of the housing, and a printer device 11 that forms an image by an electrophotographic technique is disposed above the sheet feeder device 12. Further, a fixing device 15 that fixes a toner image formed on a sheet by heating and pressing is disposed in the printer device 11.

The print job received from the external terminal device includes image data. The image data is formed with multilevel digital signals of red (R), green (G), and blue (B). The received image data is subjected to various kinds of data processing in a main control unit 100, which will be described later, and is further converted into image data of the respective reproduction colors of yellow (Y), magenta (M), cyan (C), and black (K).

The printer device 11 includes an intermediate transfer belt, a driving roller that stretches the intermediate transfer belt, a driven roller, a backup roller, image forming units for the respective colors that are disposed to face the intermediate transfer belt at predetermined intervals in the running direction A of the intermediate transfer belt, a fixing unit 13, the main control unit 100, and the like.

Each image forming unit includes a photosensitive drum as an image carrier, an LED array for exposing and scanning the surface of the photosensitive drum, a charger, a developing machine, a cleaner, and a primary transfer roller.

The sheet feeder device 12 includes a plurality of sheet feeder cassettes that store recording sheets of different sizes, and a plurality of pickup rollers for feeding out the recording sheets from the respective sheet feeder cassettes to the conveyance path.

In each image forming unit, each photosensitive drum is uniformly charged by the charger, and is exposed by the LED array, so that an electrostatic latent image is formed on the surface of the photosensitive drum. The respective electrostatic latent images are developed by the developing machines for the respective colors, and toner images in the respective colors (Y through K colors) are formed on the surfaces of the respective photosensitive drums. The toner images are sequentially transferred onto the surface of the intermediate transfer belt, by virtue of electrostatic actions of the respective primary transfer rollers disposed on the back surface side of the intermediate transfer belt.

Meanwhile, in synchronization with the image forming operations by the respective image forming units, a recording sheet S is supplied from one of the sheet feeder cassettes of the sheet feeder device 12, and is conveyed in the conveyance path to the position (a secondary transfer position) at which the secondary transfer roller and the backup roller face each other via the intermediate transfer belt. At the secondary transfer position, the toner images in Y through K colors on the intermediate transfer belt are transferred onto the recording sheet S through secondary transfer, by virtue of an electrostatic action of the secondary transfer roller. The recording sheet S on which the toner images in the Y through K colors are transferred through secondary transfer is further conveyed to the fixing unit 13.

When the toner images on the surface of the recording sheet S pass through a fixing nip 57 (FIG. 2) formed between a pressure roller 51 (a pressure applier) and a fixing belt 52 pressed against the pressure roller 51 in the fixing unit 13, the toner images are fused and fixed to the surface of the recording sheet S by heating and pressing. After having passed through the fixing unit 13, the recording sheet S is sent onto a tray 14.

### 1.2. Fixing Unit 13

As shown in FIG. 2, the fixing unit 13 has the endless fixing belt 52 wound a fixing pad 56 and a heating roller 53, and the pressure roller 51 presses the fixing pad 56 (a pressure receiver) via the fixing belt 52.

When a recording sheet S passes through the fixing nip 57 formed by the contact between the fixing belt 52 and the pressure roller 51, the toner images transferred onto the recording sheet S are fixed to the recording sheet S by heating and pressing.

### Pressure Roller 51

The pressure roller 51 is formed by coating the circumferential surface of a cylindrical cored bar made of a metal such as aluminum with an elastic layer of rubber or the like, and further coating the circumferential surface of the elastic layer with a heat-resistant release layer. The pressure roller 51 presses the fixing pad 56 via the fixing belt 52, using a biasing force of a biasing member (not shown). As a result, the fixing nip 57, which is the contact region between the fixing belt 52 and the pressure roller 51, is formed.

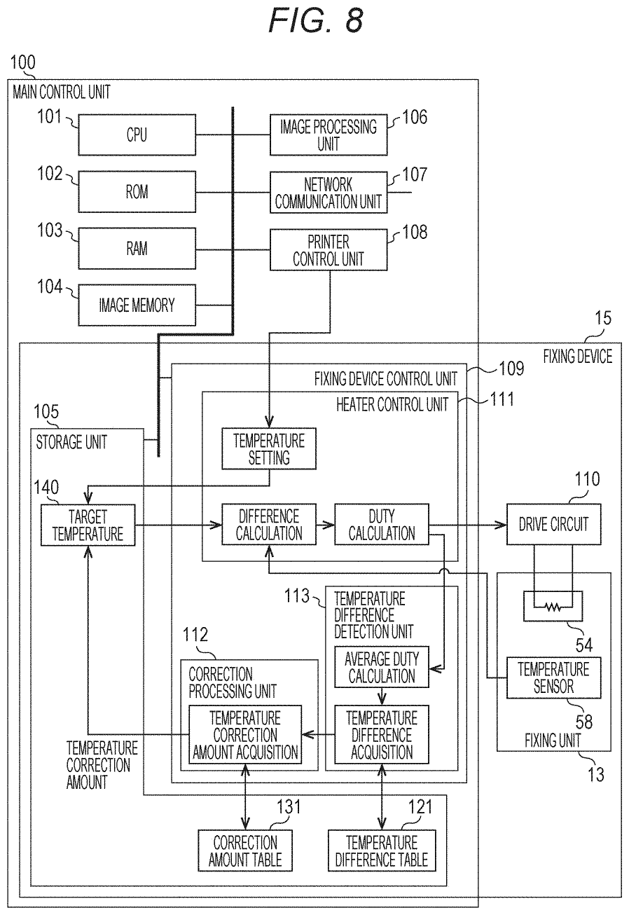

The pressure roller 51 rotates using a rotational driving force of a drive motor (not shown), under the control of a fixing device control unit 109 (FIG. 8). The fixing belt 52 revolves following the rotation of the pressure roller 51, and the heating roller 53 rotates following the revolving motion of the fixing belt 52.

### Heating Roller 53

The heating roller 53 is formed by coating the circumferential surface of a cylindrical cored bar made of a metal such as aluminum with a heat-resistant release layer. A fixing heater 54 (a heat source) is contained as a heat source in the cored bar. The fixing heater 54 is a halogen heater, for example. The amount of heat to be generated from the fixing heater 54 varies with supplied power.

The heating roller 53 and the fixing heater 54 are disposed on the inner circumferential side of the fixing belt 52, and part of the outer circumferential surface of the heating roller 53 is in contact with part of the inner circumferential surface of the fixing belt 52. Heat supplied from the fixing heater 54 is transmitted to the fixing belt 52.

### Fixing Pad 56 and Support Member 55

The fixing pad 56 is formed with a heat-resistant resin. A cross-section of the surface of the fixing pad 56 on the side of the pressure roller 51 has a curved shape that gradually protrudes toward the pressure roller 51 in terms of the direction toward the downstream side in the direction of conveyance of a recording sheet S. The fixing pad 56 is supported by a support member 55 on the surface on the opposite side from the pressure roller 51.

The support member 55 is made of a metal such as aluminum, and has a U-shaped cross-section.

The fixing pad 56 and the support member 55 are disposed on the inner circumferential side of the fixing belt 52.

### Fixing Belt 52

The fixing belt 52 is formed in an endless belt-like shape, is stretched around the fixing pad 56 and the heating roller 53, and is driven by a driving force of the pressure roller 51, to revolve in the direction indicated by an arrow X. In the fixing belt 52, the upper layer of a base layer made of polyimide is coated with an elastic layer of rubber, and the upper layer surface of the elastic layer is further coated with a surface layer that is a release layer made of PFA (tetrafluoroethylene-perfluoroalkyl vinyl ether copolymer) or PTFE (tetrafluoroethylene resin).

As shown in FIG. 2, in the revolving path of the fixing belt 52, a temperature sensor 58 that measures the temperature of the outer circumferential surface of the fixing belt 52 is disposed at a position at a certain distance from the outer circumferential surface of the fixing belt 52, the position corresponding to a position at which the fixing belt 52 and the heating roller 53 are in contact with each other. That is, the temperature sensor 58 is disposed at a position within a predetermined distance from the fixing heater 54 (in the vicinity of the fixing heater 54). Alternatively, the temperature sensor 58 may be provided at the position closest to the fixing nip 57 among positions within the predetermined distance from the fixing heater 54.

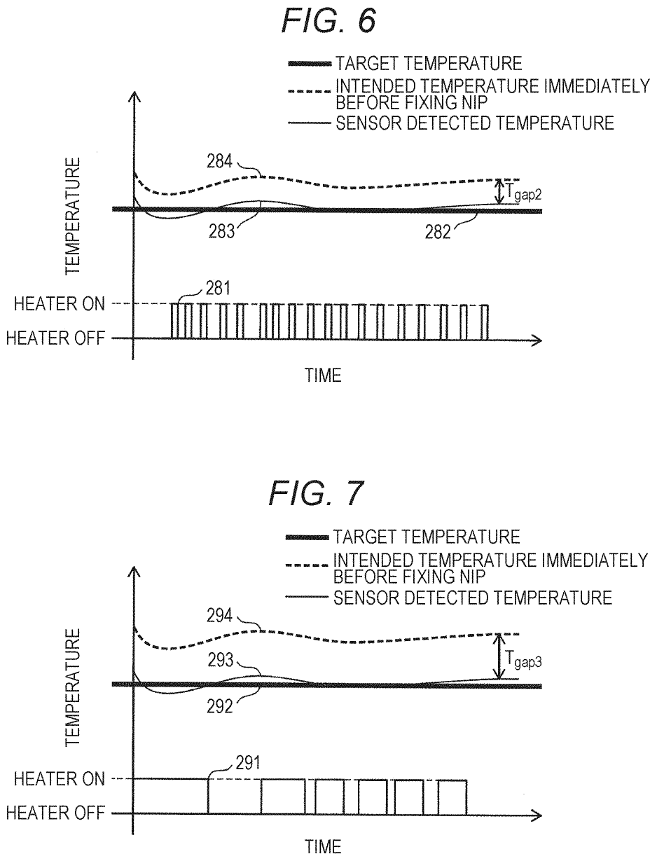

A heater control unit 111 (FIG. 8) that is included in the main control unit 100 and is in the fixing device control unit 109, which will be described later, generates a control signal (FIGS. 6 and 7) that periodically switches on and off in accordance with a turn-on DUTY (a turn-on ratio), on the basis of the temperature of the outer circumferential surface of the fixing belt 52 detected by the temperature sensor 58 and the target temperature of the fixing unit 13. The heater control unit 111 then supplies the generated control signal to a drive circuit 110 (FIGS. 1 and 8). The drive circuit 110 performs switching of a full-wave rectified alternating current using the control signal to generate a drive current for repeating supplying and shutting off power in each cycle, and supplies the generated drive current to the fixing heater 54 that heats the heating roller 53. In this manner, the heater control unit 111 repeats the supply and shut-off of power to the fixing heater 54 in each cycle in accordance with the turn-on DUTY, to control the power supply to the fixing heater 54 so that the temperature detected by the temperature sensor 58 becomes equal to the target temperature. Here, the turn-on DUTY is the ratio of the power supply time for the fixing heater 54 in each cycle of the drive current (or the ratio of the ON time in each cycle in the control signal).

### Temperature Conduction in the Fixing Belt 52

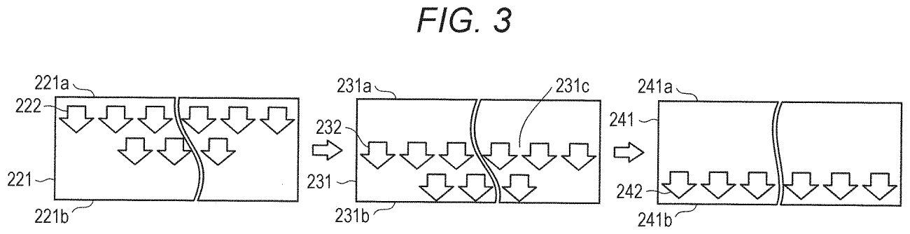

As described above, since the fixing belt 52 is stretched around the heating roller 53, the heat supplied by the fixing heater 54 in the heating roller 53 is transmitted to the fixing belt 52 via the heating roller 53. This heat transfer will be described below with reference to FIG. 3, taking a portion of the fixing belt 52 as an example.

FIG. 3 schematically shows the heat transfer in the fixing belt 52 until the portion moves from a vicinity of the fixing heater 54 to the position of the fixing nip 57 in synchronization with the revolving motion of the fixing belt 52. Specifically, FIG. 3 shows the heat transfer at the time (a) when the portion reaches the vicinity of the fixing heater 54 (time t=t0), the heat transfer at the time (b) when the portion reaches the middle position between the vicinity of the fixing heater 54 and the fixing nip 57 (time t=tm), and the heat transfer at the time (c) when the portion reaches the position immediately before the fixing nip 57 (time t=tn).

In FIG. 3, cross-sections 221, 231, and 241 are axial cross-sections of the portion of the fixing belt 52 in the respective cases where the portion of the fixing belt 52 has reached the positions of (a), (b), and (c).

The cross-section 221 shows the case where the portion of the fixing belt 52 has reached the position of (a). Therefore, in the cross-section 221, heat 222 has reached the side closer to the inner circumferential surface 221a than to the outer circumferential surface 221b of the fixing belt 52.

The cross-section 231 shows the case where the portion of the fixing belt 52 has reached the position of (b). Therefore, the heat has moved from the side closer to the inner circumferential surface 231a toward a middle portion 231c between the inner circumferential surface 231a and the outer circumferential surface 231b, and heat 232 has reached the middle portion 231c.

Further, the cross-section 241 shows the case where the portion of the fixing belt 52 has reached the position of (c). Therefore, the heat has moved from the side closer to the inner circumferential surface 241a toward the side closer to the outer circumferential surface 241b, and heat 242 has reached the side closer to the outer circumferential surface 241b.

It should be carefully noted that FIG. 3 does not show changes in temperature in the respective cross-sections of (a), (b), and (c), but shows movement of heat.

### Temperature Difference in the Thickness Direction in the Fixing Belt 52

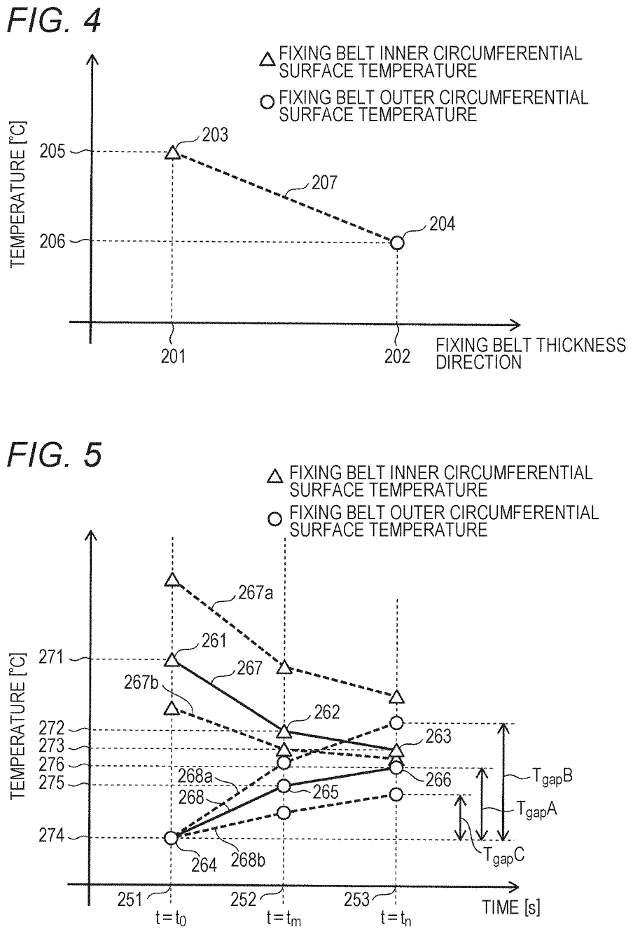

FIG. 4 shows a temperature change in the thickness direction between the temperature of the inner circumferential surface and the temperature of the outer circumferential surface at a predetermined position in the fixing belt 52. In this graph, the abscissa axis indicates the thickness direction of the fixing belt 52, and the ordinate axis indicates temperature. A point 203 in this graph was obtained by plotting the temperature 205 of the inner circumferential surface at a position 201 in the abscissa axis direction corresponding to the inner circumferential surface of the fixing belt 52, and a point 204 was obtained by plotting the temperature 206 of the outer circumferential surface at a position 202 in the abscissa axis direction corresponding to the outer circumferential surface of the fixing belt 52. The temperature 205 of the inner circumferential surface is higher than the temperature 206 of the outer circumferential surface. As indicated by an imaginary line 207 connecting the point 203 and the point 204, the temperature in the fixing belt 52 is not constant, and it is considered that a temperature difference is generated between the temperature in the inner circumferential surface and the temperature in the outer circumferential surface, in the direction from the inner circumferential surface toward the outer circumferential surface.

### Temperature Changes in the Outer Circumferential Surface and the Inner Circumferential Surface

In FIG. 5, polygonal lines 267 and 268 indicate the respective temperature changes in the outer circumferential surface and the inner circumferential surface of a portion of the fixing belt 52 in the cases where the portion has reached the positions of (a), (b), and (c). In this graph, the abscissa axis indicates time, and the ordinate axis indicates temperature.

Here, the polygonal lines 267 and 268 indicate temperature changes in a case where a certain heat supply P-A is made from the fixing heater 54 (a case where the turn-on DUTY of the fixing heater 54 is a certain value (turn-on DUTY-A)).

In this graph, a point 261 and a point 264 were obtained by plotting the temperature 271 of the inner circumferential surface and the temperature 274 of the outer circumferential surface at a position 251 in the abscissa axis direction corresponding to the time (t=t0) when the portion of the fixing belt 52 reaches the position of (a).

A point 262 and a point 265 were obtained by plotting the temperature 272 of the inner circumferential surface and the temperature 275 of the outer circumferential surface at a position 252 in the abscissa axis direction corresponding to the time (t=tm) when the portion of the fixing belt 52 reaches the position of (b).

Further, a point 263 and a point 266 were obtained by plotting the temperature 273 of the inner circumferential surface and the temperature 276 of the outer circumferential surface at a position 253 in the abscissa axis direction corresponding to the time (t=tn) when the portion of the fixing belt 52 reaches the position of (c).

As can be seen from FIG. 5, as the portion of the fixing belt 52 moves from the position of (a) to the position of (c), the temperature in the inner circumferential surface of the portion drops, and the temperature in the outer circumferential surface rises. This is because the heat supplied by the fixing heater 54 in the heating roller 53 is transmitted from the inner circumferential surface of the fixing belt 52 to the outer circumferential surface via the heating roller 53.

Further, there is a temperature difference TgapA between the temperature 274 of the outer circumferential surface of the fixing belt 52 at the time (time t=t0) when the portion of the fixing belt 52 reaches the vicinity of the fixing heater 54, and the temperature 276 of the outer circumferential surface of the fixing belt 52 at the time (time t=tn) when the portion reaches the position immediately before the fixing nip 57.

Accordingly, even if the temperature of the outer circumferential surface of the fixing belt 52 in the vicinity of the fixing heater 54 is measured, and energization control is performed on the fixing heater 54 so that the measured temperature becomes equal to the target temperature, the temperature of the outer circumferential surface of the fixing belt 52 in the vicinity of the fixing heater 54 differs from the temperature of the fixing belt 52 at the position immediately before the fixing nip 57 by the temperature difference TgapA.

It is considered that this temperature difference TgapA is generated depending on the temperature difference between the inner circumferential surface and the outer circumferential surface of the fixing belt 52 in the vicinity of the fixing heater 54.

### Temperature Changes in the Outer Circumferential Surface and the Inner Circumferential Surface in a Case where the Heat Supplies are Different

In FIG. 5, polygonal lines 267a and 268a indicate the respective temperature changes in the outer circumferential surface and the inner circumferential surface of a portion of the fixing belt 52 when the portion reaches the positions of (a), (b), and (c) in a case where the heat supply from the fixing heater 54 is larger than the heat supply P-A (a case where the turn-on DUTY of the fixing heater 54 is higher than the turn-on DUTY-A).

In this case, the temperature of the outer circumferential surface of the fixing belt 52 in the vicinity of the fixing heater 54 indicated by the polygonal line 268a is the same as the temperature 274 indicated by the polygonal line 268, and there is no change. On the other hand, the temperature of the inner circumferential surface of the fixing belt 52 in the vicinity of the fixing heater 54 indicated by the polygonal line 267a is higher than the temperature 271 indicated by the polygonal line 267. Accordingly, the temperature of the inner circumferential surface of the fixing belt 52 at the position immediately before the fixing nip 57 indicated by the polygonal line 267a is also higher than the temperature 273 indicated by the polygonal line 267. Further, the temperature of the outer circumferential surface of the fixing belt 52 at the position immediately before the fixing nip 57 indicated by the polygonal line 268a is also higher than the temperature 276 indicated by the polygonal line 268. As a result of this, the temperature difference TgapB between the temperature of the outer circumferential surface of the fixing belt 52 in the vicinity of the fixing heater 54 and the temperature of the outer circumferential surface of the fixing belt 52 at the position immediately before the fixing nip 57 is larger than the temperature difference TgapA.

Further, in FIG. 5, polygonal lines 267b and 268b indicate the temperature changes in the outer circumferential surface and the inner circumferential surface of a portion of the fixing belt 52 when the portion reaches the positions of (a), (b), and (c) in a case where the heat supply from the fixing heater 54 is smaller than the heat supply P-A (a case where the turn-on DUTY of the fixing heater 54 is lower than the turn-on DUTY-A).

In this case, the temperature of the outer circumferential surface of the fixing belt 52 in the vicinity of the fixing heater 54 indicated by the polygonal line 268b is the same as the temperature 274 indicated by the polygonal line 268, and there is no change. On the other hand, the temperature of the inner circumferential surface of the fixing belt 52 in the vicinity of the fixing heater 54 indicated by the polygonal line 267b is lower than the temperature 271 indicated by the polygonal line 267. Accordingly, the temperature of the inner circumferential surface of the fixing belt 52 at the position immediately before the fixing nip 57 indicated by the polygonal line 267b is also lower than the temperature 273 indicated by the polygonal line 267. Further, the temperature of the outer circumferential surface of the fixing belt 52 at the position immediately before the fixing nip 57 indicated by the polygonal line 267b is also lower than the temperature 276 indicated by the polygonal line 267. As a result of this, the temperature difference TgapC between the temperature of the outer circumferential surface of the fixing belt 52 in the vicinity of the fixing heater 54 and the temperature of the outer circumferential surface of the fixing belt 52 at the position immediately before the fixing nip 57 is smaller than the temperature difference TgapA.

In this manner, between a case where the heat supply from the fixing heater 54 is small (the turn-on DUTY of the fixing heater 54 is low) and a case where the heat supply from the fixing heater 54 is large (the turn-on DUTY of the fixing heater 54 is high), a difference is generated in the temperature difference between the temperature of the outer circumferential surface of the fixing belt 52 in the vicinity of the fixing heater 54 and the temperature of the outer circumferential surface of the fixing belt 52 at the position immediately before the fixing nip 57 (TgapB>TgapC).

As described above, it is considered that the temperature difference between the temperature of the outer circumferential surface of the fixing belt 52 in the vicinity of the fixing heater 54 and the temperature of the outer circumferential surface of the fixing belt 52 at the position immediately before the fixing nip 57 varies with the amount of heat generated by the fixing heater 54.

### Temperature Change Over Time

The upper portion of FIG. 6 shows a target temperature 282, a temporal change 283 in the temperature detected by the temperature sensor 58, and a temporal change 284 in the intended temperature at the position immediately before the fixing nip 57, in a case where the heat supply from the fixing heater 54 is small (a case where the turn-on DUTY of the fixing heater 54 is low). The lower portion of FIG. 6 shows a control signal 281 for controlling energization of the fixing heater 54 by switching between ON and OFF. In FIG. 6, the abscissa axis indicates the passage of time. In the upper portion of FIG. 6, the ordinate axis indicates temperature. In the lower portion of FIG. 6, the ordinate axis indicates the changes in the control signal switching between ON and OFF.

Further, the upper portion of FIG. 7 shows a target temperature 292, a temporal change 293 in the temperature detected by the temperature sensor 58, and a temporal change 294 in the intended temperature at the position immediately before the fixing nip 57, in a case where the heat supply from the fixing heater 54 is large (a case where the turn-on DUTY of the fixing heater 54 is high). The lower portion of FIG. 7 shows a control signal 291 for controlling energization of the fixing heater 54. In FIG. 7, the abscissa axis indicates the passage of time. In the upper portion of FIG. 7, the ordinate axis indicates temperature. In the lower portion of FIG. 7, the ordinate axis indicates the changes in the control signal switching between ON and OFF.

In FIG. 6, the turn-on DUTY of the control signal 281 is set so that the temporal change 283 in the temperature detected by the temperature sensor 58 approaches the target temperature 282. In this case, there is a constant temperature difference Tgap2 between the temporal change 284 in the intended temperature at the position immediately before the fixing nip 57 and the temporal change 283 in the detected temperature.

In FIG. 7, on the other hand, the turn-on DUTY of the control signal 291 is set so that the temporal change 293 in the temperature detected by the temperature sensor 58 approaches the target temperature 292. In this case, there is a constant temperature difference Tgap3 between the temporal change 294 in the intended temperature at the position immediately before the fixing nip 57 and the temporal change 293 in the detected temperature.

As described above, the temperature difference Tgap2 shown in FIG. 6 is different from the temperature difference Tgap3 shown in FIG. 7 (Tgap2<Tgap3). In other words, between a case where the heat supply from the fixing heater 54 is small (the turn-on DUTY of the fixing heater 54 is low) and a case where the heat supply from the fixing heater 54 is large (the turn-on DUTY of the fixing heater 54 is high), the target temperature is the same, but there is a difference between the temperature difference Tgap2 shown in FIG. 6 and the temperature difference Tgap3 shown in FIG. 7.

As described above, depending on the temperature difference between the temperature of the inner circumferential surface and the temperature of the outer circumferential surface in the thickness direction in the fixing belt 52 in the vicinity of the fixing heater 54, a temperature difference is generated between the temperature of the outer circumferential surface of the fixing belt 52 detected in the vicinity of the fixing heater 54 and the temperature of the outer circumferential surface of the fixing belt 52 at the fixing nip 57. As a result, even when the fixing heater 54 is controlled so that the temperature of the outer circumferential surface of the fixing belt 52 detected in the vicinity of the fixing heater 54 becomes equal to the target temperature, there is a possibility that the amount of heat to be supplied to a recording sheet might be insufficient or excessive at the fixing nip 57, depending on the amount of heat generated from the fixing heater 54, even under the condition that the system speed of the image forming apparatus 10 and the type of recording sheet remain the same.

Therefore, in this embodiment of the present invention, the temperature difference indicating the inclination in the thickness direction between the temperature of the inner circumferential surface and the temperature of the outer circumferential surface of the fixing belt 52 is calculated (or estimated), and the target temperature in the fixing unit 13 is corrected on the basis of the calculated (or estimated) temperature difference. Thus, the amount of heat to be supplied to a recording sheet is optimized.

### 1.3. Main Control Unit 100

As shown in FIG. 8, the main control unit 100 includes a CPU 101, a ROM 102, a RAM 103, an image memory 104, a storage unit 105, an image processing unit 106, a network communication unit 107, a printer control unit 108, and a fixing device control unit 109.

When the main control unit 100 receives a print job from an external terminal device, the main control unit 100 collectively controls the image memory 104, the storage unit 105, the image processing unit 106, the network communication unit 107, the printer control unit 108, the fixing device control unit 109, and the like, so that an image is formed on a recording sheet by an electrophotographic technique and is output, in accordance with the received print job.

In accordance with a print job received from an external terminal device, for example, the image processing unit 106 performs various kinds of data processing on image data formed with multilevel digital signals of R, G, and B, to convert the image data into image data of the respective reproduction colors of Y, M, C, and K.

The printer control unit 108 integrally controls a feeding operation of the sheet feeder device 12 and image forming operations of the image forming units for the respective reproduction colors in the printer device 11, so that an image forming operation is performed.

The fixing device control unit 109 controls a fixing operation in the fixing unit 13. The fixing device control unit 109 will be described later in detail.

The network communication unit 107 receives a print job from an external terminal device via a network such as a LAN. The network communication unit 107 also outputs a message or the like to the external terminal device, as necessary.

The RAM 103 temporarily stores various kinds of control variables and the like, and provides a work area at a time of program execution by the CPU 101.

The ROM 102 stores a control program or the like for executing various kinds of jobs such as a printing operation.

The CPU 101 operates in accordance with the control program stored in the ROM 102, to control the image processing unit 106, the network communication unit 107, the printer control unit 108, the fixing device control unit 109, and the like. For example, the CPU 101 operates in accordance with the control program, and, upon receipt of a print job from the network communication unit 107, instructs the printer control unit 108 to execute an image forming operation on the basis of the print job.

The image memory 104 temporarily stores image data of a print job or the like.

The storage unit 105 will be described below in detail.

Note that the fixing device control unit 109, the storage unit 105, the drive circuit 110, and the fixing unit 13 described above constitute the fixing device 15.

### 1.4. Storage Unit 105

The storage unit 105 is formed with a nonvolatile semiconductor memory, for example.

As shown in FIG. 8, the storage unit 105 includes an area for storing a target temperature 140, and stores a correction amount table 131 and a temperature difference table 121.

### Target Temperature 140

The target temperature 140 indicates the temperature that should be set in the fixing unit 13. The target temperature 140 is set by the heater control unit 111.

### Temperature Difference Table 121

The temperature difference table 121 is a data table showing the relationship between the turn-on DUTY of a control signal supplied from the heater control unit 111 to the drive circuit 110, and the temperature difference in the fixing belt 52.

Here, the temperature difference in the fixing belt 52 is the temperature difference at the position where the temperature sensor 58 is disposed in the revolving path of the fixing belt 52, for example. Note that the temperature difference in the fixing belt 52 may be a temperature difference generated at any position in the revolving direction from the installation position of the fixing heater 54 to the position immediately before the fixing nip 57 in the revolving path of the fixing belt 52.

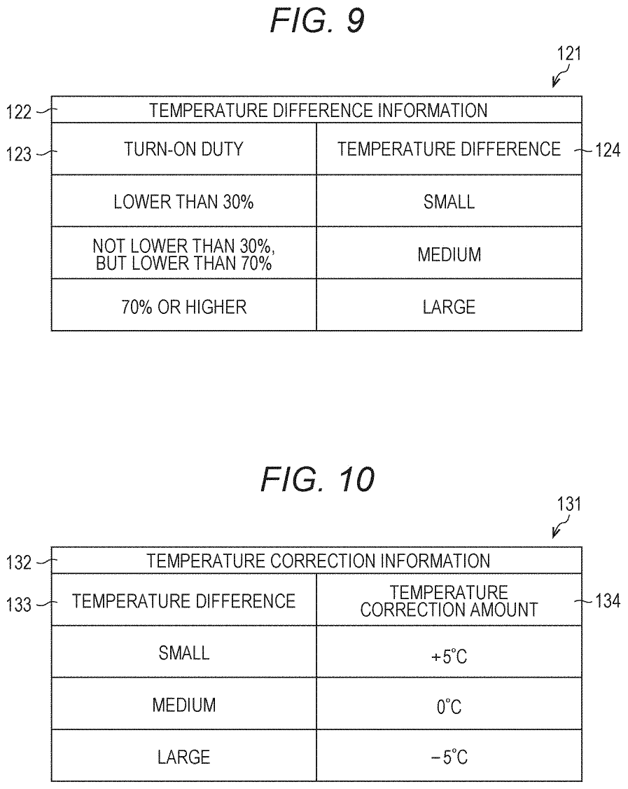

As shown in FIG. 9, the temperature difference table 121 contains a plurality of pieces of temperature difference information. Each piece of temperature difference information includes a turn-on DUTY and a temperature difference.

In the temperature difference information, when the turn-on DUTY is lower than 30%, “SMALL” indicating that the temperature difference is small is set as the temperature difference between the inner circumferential surface and the outer circumferential surface.

In the temperature difference information, when the turn-on DUTY is not lower than 30% but lower than 70%, “MEDIUM” indicating that the temperature difference is moderate is set as the temperature difference between the inner circumferential surface and the outer circumferential surface.

Further, in the temperature difference information, when the turn-on DUTY is 70% or higher, “LARGE” indicating that the temperature difference is large is set as the temperature difference between the inner circumferential surface and the outer circumferential surface.

Since the data structure of the temperature difference table 121 is as described above, it is possible to determine the temperature difference in the fixing belt 52 as an estimated value from the turn-on DUTY of the control signal supplied from the heater control unit 111 to the drive circuit 110, using the temperature difference table 121.

### Correction Amount Table 131

The correction amount table 131 is a data table showing the relationship between the temperature difference in the fixing belt 52 and the temperature correction amount with respect to the target temperature to be set in the fixing nip 57.

As shown in FIG. 10, the correction amount table 131 contains a plurality of pieces of temperature correction information. Each piece of temperature correction information includes a temperature difference and a temperature correction amount.

In the temperature correction information, when “SMALL” indicating that the temperature difference in the fixing belt 52 is small is set, “+5° C.” is set as the temperature correction amount.

Further, when “MEDIUM” indicating that the temperature difference in the fixing belt 52 is moderate is set in the temperature correction information, “0° C.” is set as the temperature correction amount.

Further, when “LARGE” indicating that the temperature difference in the fixing belt 52 is large is set in the temperature correction information, “−5° C.” is set as the temperature correction amount.

Since the data structure of the correction amount table 131 is as described above, it is possible to determine the temperature correction amount with respect to the target temperature to be set in the fixing nip 57 from the temperature difference in the fixing belt 52, using the correction amount table 131.

### Temperature Difference Function and Correction Function

The storage unit 105 may store a temperature difference function and a correction function, instead of the temperature difference table 121 shown in FIG. 9 and the correction amount table 131 shown in FIG. 10.

The temperature difference function outputs a temperature difference between the inner circumferential surface and the outer circumferential surface of the fixing belt 52, in accordance with the value of the turn-on DUTY of the control signal supplied from the heater control unit 111 to the drive circuit 110.

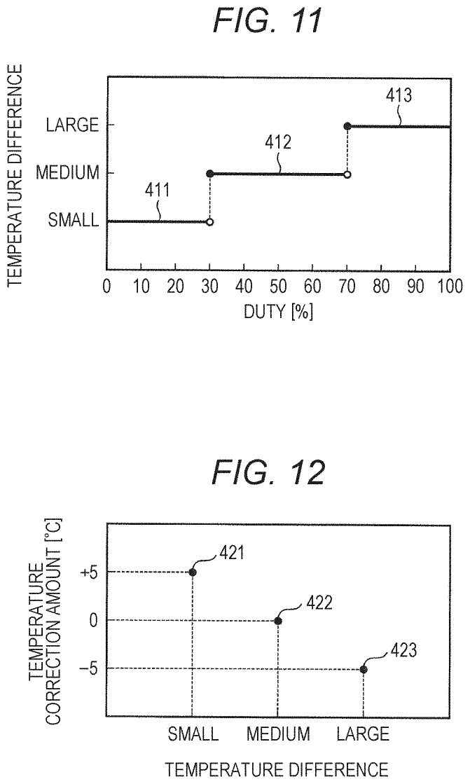

FIG. 11 is a graph showing the relationship between the value of the turn-on DUTY and the temperature difference in the temperature difference function. In this graph, a line 411, a line 412, and a line 413 indicate the relationship between the value of the turn-on DUTY and the temperature difference.

As indicated by the line 411, when the turn-on DUTY is lower than 30%, “SMALL” is set as the temperature difference.

As indicated by the line 412, when the turn-on DUTY is not lower than 30% but lower than 70%, “MEDIUM” is set as the temperature difference.

Further, as indicated by the line 413, when the turn-on DUTY is 70% or higher, “LARGE” is set as the temperature difference.

Since the temperature difference function is as described above, it is possible to determine the temperature difference in the fixing belt 52 from the turn-on DUTY of the control signal supplied from the heater control unit 111 to the drive circuit 110, using the temperature difference function.

Further, the correction function outputs, as an estimated value, the temperature correction amount with respect to the target temperature to be set in the fixing unit 13, in accordance with the temperature difference.

FIG. 12 is a graph showing the relationship between the temperature difference and the temperature correction amount in the correction function. In this graph, a point 421, a point 422, and a point 423 indicate the relationship between the temperature difference and the temperature correction amount.

As indicated by the point 421, when the temperature difference is “SMALL”, “+5° C.” is set as the temperature correction amount.

As indicated by the point 422, when the temperature difference is “MEDIUM”, “0° C.” is set as the temperature correction amount.

Further, as indicated by the point 423, when the temperature difference is “LARGE”, “−5° C.” is set as the temperature correction amount.

Since the correction function is as described above, it is possible to determine the temperature correction amount with respect to the target temperature to be set in the fixing unit 13 from the temperature difference in the fixing belt 52, using the correction function.

### 1.5. Fixing Device Control Unit 109

The fixing device control unit 109 (FIG. 8) includes a CPU, a ROM, and a RAM (not shown). A computer program for control is stored in the ROM or the RAM. Further, the RAM temporarily stores various kinds of control variables and the like, and provides a work area at a time of program execution by the CPU.

As shown in FIG. 8, the fixing device control unit 109 includes, as its functions, the heater control unit 111, a correction processing unit 112 (a corrector), and a temperature difference detection unit 113 (a temperature difference detector).

As the CPU operates in accordance with the computer program for control stored in the ROM or the RAM, the heater control unit 111, the correction processing unit 112, and the temperature difference detection unit 113 execute these functions.

### (1) Heater Control Unit 111

### Control on Power Supply to the Fixing Heater 54

The heater control unit 111 repeats the supply and shut-off of power to the fixing heater 54 in accordance with the turn-on DUTY (turn-on ratio) indicating the time of power supply to the fixing heater 54 in one cycle, so that the temperature detected by the temperature sensor 58 becomes equal to the target temperature 140.

### Temperature Setting

The heater control unit 111 receives from the printer control unit 108 designation of a mode such as a warm-up mode, a print mode, or a power-saving mode, designation of the type of image (such as text or photograph or the like) to be formed on a recording sheet, and the like. Upon receipt of such designation, the heater control unit 111 sets the target temperature to be set in the fixing unit 13 on the basis of the received designation, and writes the set target temperature as the target temperature 140 into the storage unit 105.

### Difference Calculation

The heater control unit 111 receives the temperature detected by the temperature sensor 58, from the temperature sensor 58 of the fixing unit 13. The heater control unit 111 also reads the target temperature 140 from the storage unit 105.

The heater control unit 111 then calculates the difference between the target temperature 140 and the detected temperature according to the following equation.

Difference=target temperature−detected temperature

### Turn-on DUTY Calculation

The heater control unit 111 then determines whether the calculated difference is 0, or whether the detected temperature is within a predetermined range from the target temperature.

In a case where the difference is 0, or where the detected temperature is within the predetermined range from the target temperature, the heater control unit 111 supplies a control signal that repeatedly switches on and off to the drive circuit 110, without changing the current turn-on DUTY. In this case, the heater control unit 111 also instructs the temperature difference detection unit 113 to start detecting a temperature difference.

In a case where the detected temperature is not within the predetermined range from the target temperature, and the difference has a positive value, the heater control unit 111 changes the current turn-on DUTY so that the turn-on time of the fixing heater 54 becomes longer than the current turn-on time by a predetermined time, and then supplies the drive circuit 110 with a control signal that repeatedly switches on and off after the change of the turn-on DUTY.

In a case where the detected temperature is not within the predetermined range from the target temperature, and the difference has a negative value, the heater control unit 111 changes the current turn-on DUTY so that the turn-on time of the fixing heater 54 becomes shorter than the current turn-on time by a predetermined time, and then supplies the drive circuit 110 with a control signal that repeatedly switches on and off after the change of the turn-on DUTY.

The heater control unit 111 also continues to output the turn-on DUTY to the temperature difference detection unit 113.

### (2) Temperature Difference Detection Unit 113

In the time period during which a recording sheet passes through the fixing nip 57, at the position corresponding to the installation position of the temperature sensor 58 in the revolving path of the fixing belt 52, the temperature difference detection unit 113 detects a temperature difference between the inner circumferential surface and the outer circumferential surface of the fixing belt 52 by estimating the temperature difference prior to target temperature correction by the correction processing unit 112 as described below, on the basis of the turn-on DUTY used by the heater control unit 111.

The temperature difference detection unit 113 receives, from the heater control unit 111, an instruction to start temperature difference detection. Receiving this instruction, the temperature difference detection unit 113 calculates an average DUTY and acquires the temperature difference as described below.

### Calculation of Average DUTY

The temperature difference detection unit 113 continuously receives the turn-on DUTY from the heater control unit 111. The temperature difference detection unit 113 calculates the average value of the turn-on DUTY receiving during a predetermined period.

### Acquisition of Temperature Difference

The temperature difference detection unit 113 reads the temperature difference corresponding to the calculated average value of the turn-on DUTY from the temperature difference table 121 stored in the storage unit 105, to acquire the temperature difference. The temperature difference detection unit 113 outputs the acquired temperature difference to the correction processing unit 112.

### (3) Correction Processing Unit 112

The correction processing unit 112 corrects the target temperature on the basis of the temperature difference as described below.

### Acquisition of Temperature Correction Amount

The correction processing unit 112 receives the temperature difference from the temperature difference detection unit 113.

The correction processing unit 112 then reads the temperature correction amount corresponding to the received temperature difference from the correction amount table 131 stored in the storage unit 105, to acquire the temperature correction amount.

### Target Temperature Correction

The correction processing unit 112 then corrects the target temperature 140 already set and written in the storage unit 105, on the basis of the acquired temperature correction amount.

For example, in a case where the received temperature correction amount is “−5° C.”, the correction processing unit 112 adds “−5° C.” to the target temperature 140 written in the storage unit 105, to correct the target temperature. The correction processing unit 112 then writes the corrected target temperature as the target temperature 140 into the storage unit 105.

For example, in a case where the received temperature correction amount is “5° C.”, the correction processing unit 112 adds “5° C.” to the target temperature 140 written in the storage unit 105, to correct the target temperature. The correction processing unit 112 then writes the corrected target temperature as the target temperature 140 into the storage unit 105.

### 1.6. Operation of the Image Forming Apparatus 10

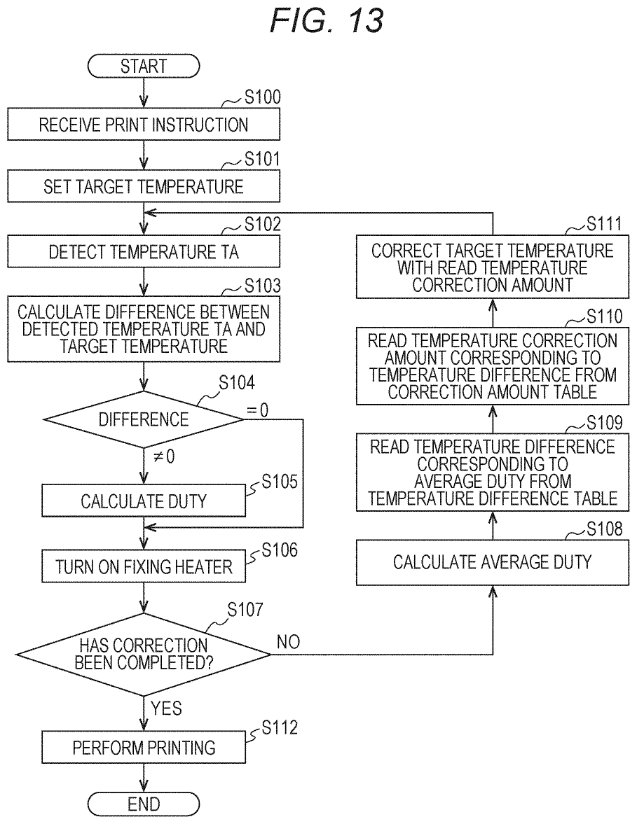

Operation of the image forming apparatus 10, or particularly, operations in the printer control unit 108 and the fixing device control unit 109 are now described with reference to the flowchart shown in FIG. 13.

The image forming apparatus 10 receives a print instruction from a user (step S100).

The heater control unit 111 sets the target temperature to be set in the fixing unit 13, and writes the set target temperature as the target temperature 140 into the storage unit 105 (step S101).

The temperature sensor 58 of the fixing unit 13 then detects the temperature TA of the outer circumferential surface of the fixing belt 52. The heater control unit 111 receives the detected temperature TA from the temperature sensor 58 (step S102).

The heater control unit 111 then calculates a difference between the target temperature 140 and the detected temperature TA (=target temperature−detected temperature) (step S103).

The heater control unit 111 then determines whether the difference is 0 (or whether the detected temperature TA is within a predetermined range from the target temperature 140) (step S104).

If the difference is not 0 (or if the detected temperature TA is not within the predetermined range from the target temperature 140) (“≠0” in step S104), the heater control unit 111 calculates a turn-on DUTY changed from the current turn-on DUTY on the basis of the calculated difference, and supplies the drive circuit 110 with a control signal that repeatedly switches on and off after the change of the turn-on DUTY (step S105).

If the difference is 0 (or if the detected temperature TA is within the predetermined range from the target temperature 140) (“=0” in step S104), the heater control unit 111 does not change the current turn-on DUTY.

The drive circuit 110 generates a drive current using the control signal, and supplies the generated drive current to the fixing heater 54. The fixing heater 54 is turned on by the drive current (step S106).

The fixing device control unit 109 then determines whether the temperature correction has been completed (step S107). If it is determined that the temperature correction has not been completed (“NO” in step S107), the temperature difference detection unit 113 calculates the average value of the turn-on DUTY during a predetermined period (step S108).

The temperature difference detection unit 113 then reads the temperature difference corresponding to the calculated average value of the turn-on DUTY from the temperature difference table 121 (step S109).

The correction processing unit 112 then reads the temperature correction amount corresponding to the received temperature difference from the correction amount table 131 (step S110).

The correction processing unit 112 corrects the target temperature 140 already set and written in the storage unit 105, on the basis of the read temperature correction amount (step S111).

The fixing device control unit 109 then moves the control on to step S102.

If the fixing device control unit 109 determines that the temperature correction has been completed (“YES” in step S107), on the other hand, the printer control unit 108 causes the printer device 11 to perform printing (step S112).

The description of operations in the printer control unit 108 and the fixing device control unit 109 not comes to an end.

### 1.7 Summation

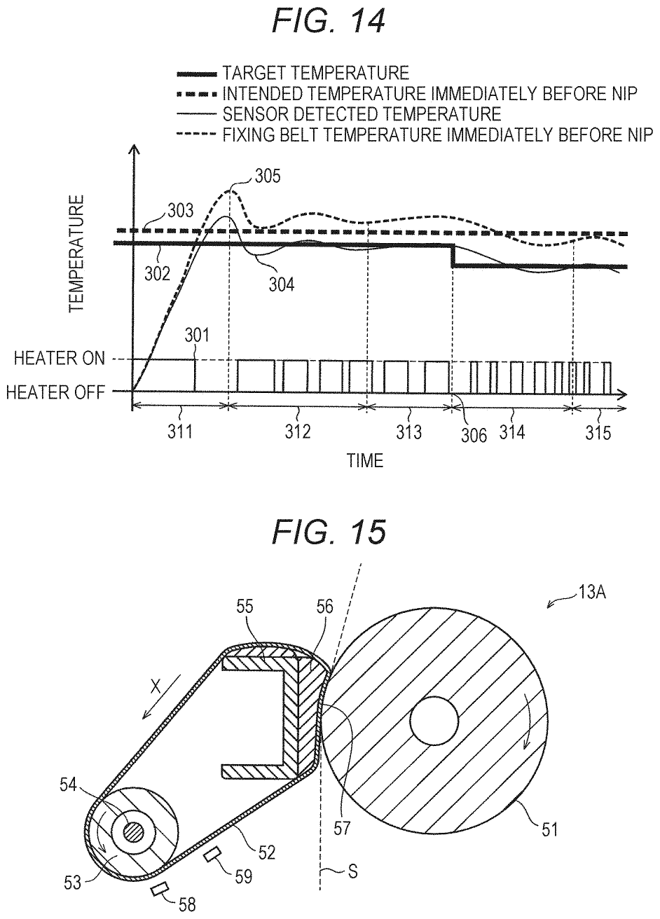

FIG. 14 shows temporal changes and the like in the target temperature, the intended temperature immediately before the fixing nip 57, the temperature detected by the temperature sensor 58, and the temperature at the position immediately before the fixing nip 57, in a case where the power supply to the fixing heater 54 is controlled after the power source of the image forming apparatus 10 is turned on.

The upper portion of FIG. 14 shows a temporal change 302 in the target temperature, an intended temperature 303 at the position immediately before the fixing nip 57, a temporal change 304 in the temperature detected by the temperature sensor 58, and a temporal change 305 in the temperature at the position immediately before the fixing nip 57. The low portion of FIG. 14 shows a control signal 301 for controlling energization of the fixing heater 54 by switching between ON and OFF. In FIG. 14, the abscissa axis indicates the passage of time. In the upper portion of FIG. 14, the ordinate axis indicates temperature. In the lower portion of FIG. 14, the ordinate axis indicates the changes in the control signal switching between ON and OFF.

During a warm-up period 311 after the power source of the image forming apparatus 10 is turned on, the temperature detected by the temperature sensor 58 increases rapidly, and quickly approaches the target temperature 302. During an unstable period 312 after the end of the warm-up period 311, the detected temperature becomes higher or lower than the target temperature 302, and fluctuates. As the unstable period 312 approaches its end, the amount of change in the detected temperature decreases. After the unstable period 312 ends, the detected temperature approaches the target temperature during a stable period 313. When a predetermined period of time has elapsed since the start of the stable period 313, the detected temperature becomes very close to the target temperature at time 306. In other words, the temperature difference between the detected temperature and the target temperature becomes extremely close to 0 (the temperature difference between the detected temperature and the target temperature falls within a predetermined range). At time 306, however, the temperature at the position immediately before the fixing nip 57 is not close to the intended temperature at the position immediately before the fixing nip 57.

At time 306 when the temperature detected by the temperature sensor 58 is stabilized, the target temperature is corrected with the temperature correction amount determined from the temperature difference between the inner circumferential surface and the outer circumferential surface of the fixing belt 52, as described above. The power supply to the fixing heater 54 is controlled so that the temperature detected by the temperature sensor 58 becomes equal to the corrected target temperature. During an unstable period 314 after time 306, the temperature at the position immediately before the fixing nip 57 becomes closer to the intended temperature at the position immediately before the fixing nip 57.

Further, during a stable period 315 after the unstable period 314, the temperature at the position immediately before the fixing nip 57 becomes very close to the intended temperature at the position immediately before the fixing nip 57.

FIG. 14 shows an example in which the turn-on DUTY is set lower in the unstable period 314 and the stable period 315 than the turn-on duty in the stable period 313 before time 306. In this example, after time 306, the amount of heat to be applied to the fixing belt 52 becomes smaller than that before time 306, and the amount of heat to be transmitted from the inner circumferential surface to the outer circumferential surface of the fixing belt 52 decreases from that before time 306.

Note that, depending on the amount of heat to be transmitted to the fixing belt 52, the turn-on DUTY may be made higher after time 306.

As described above, at time 306 when the temperature detected by the temperature sensor 58 is stabilized, the temperature difference corresponding to the calculated average value of the turn-on DUTY is read from the temperature difference table 121, and the temperature correction amount corresponding to the received temperature difference is read from the correction amount table 131. The target temperature 140 is corrected with the read temperature correction amount, and the power supply to the fixing heater 54 is controlled so that the temperature detected by the temperature sensor 58 becomes equal to the corrected target temperature. As a result, the temperature at the position immediately before the fixing nip 57 becomes equal to the intended temperature, and an excellent effect to enable application of an appropriate amount of heat to a sheet is achieved.

### 2. First Modification

A first modification of the above embodiment is now described.

### (1) Fixing Unit 13A

An image forming apparatus of the first modification includes a fixing unit 13A shown in FIG. 15, instead of the fixing unit 13 shown in FIG. 2. In the following, the description will focus on differences from the fixing unit 13 shown in FIG. 2.

The fixing unit 13A differs from the fixing unit 13 in that a temperature sensor 59 that measures the temperature of the outer circumferential surface of the fixing belt 52 is provided on the side closer to the temperature sensor 58 in the revolving path of the fixing belt 52 between the installation position of the temperature sensor 58 and the point immediately before the fixing nip 57 in the revolving direction.

In this example, the temperature sensor 58 and the temperature sensor 59 are arranged at the same position in the axial direction (the longitudinal direction) of the fixing unit 13A.

### (2) Temperature Difference Table 141

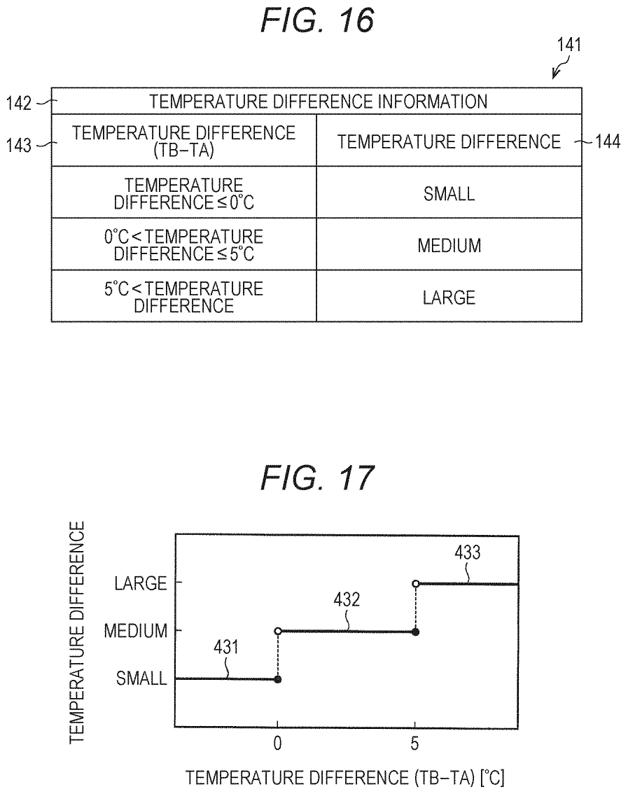

The storage unit 105 stores a temperature difference table 141 shown in FIG. 16, instead of the temperature difference table 121 shown in FIG. 9.

As shown in FIG. 16, the temperature difference table 141 contains a plurality of pieces of temperature difference information. Each piece of temperature difference information includes a temperature difference and another temperature difference.

Here, the temperature difference in the fixing belt 52 is the temperature difference at the position where the temperature sensor 58 is disposed in the revolving path of the fixing belt 52, for example. Note that the temperature difference in the fixing belt 52 may be the temperature difference at the position where the temperature sensor 59 is disposed in the revolving path of the fixing belt 52. Alternatively, the temperature difference in the fixing belt 52 may be a temperature difference at any position in the revolving direction from the installation position of the temperature sensor 58 to the point immediately before the fixing nip 57 in the revolving path of the fixing belt 52.

Here, the temperature difference is the temperature difference (TB-TA) between the temperature TB of the outer circumferential surface of the fixing belt 52 measured by the temperature sensor 59, and the temperature TA of the outer circumferential surface of the fixing belt 52 measured by the temperature sensor 58. The temperature difference is a temperature difference in the fixing belt 52.

In the temperature difference information, when the temperature difference (TB-TA) is 0° C. or lower, “SMALL” indicating that the temperature difference is small is set as the temperature difference between the inner circumferential surface and the outer circumferential surface.

In the temperature difference information, when the temperature difference (TB-TA) is larger than 0° C. but not larger than 5° C., “MEDIUM” indicating that the temperature difference is moderate is set as the temperature difference between the inner circumferential surface and the outer circumferential surface.

Further, in the temperature difference information, when the temperature difference (TB-TA) is larger than 5° C., “LARGE” indicating that the temperature difference is large is set as the temperature difference between the inner circumferential surface and the outer circumferential surface.

Since the data structure of the temperature difference table 141 is as described above, it is possible to determine a temperature difference in the fixing belt 52 from the temperature difference (TB-TA) between the temperature TB of the outer circumferential surface of the fixing belt 52 measured by the temperature sensor 59 and the temperature TA of the outer circumferential surface of the fixing belt 52 measured by the temperature sensor 58, using the temperature difference table 141.

### Temperature Difference Function

The storage unit 105 may store a temperature difference function, instead of the temperature difference table 141 shown in FIG. 16.

The temperature difference function outputs the temperature difference between the inner circumferential surface and the outer circumferential surface of the fixing belt 52, in accordance with the temperature difference (TB-TA) between the temperature TB of the outer circumferential surface of the fixing belt 52 measured by the temperature sensor 59, and the temperature TA of the outer circumferential surface of the fixing belt 52 measured by the temperature sensor 58.

FIG. 17 is a graph showing the relationship between the temperature difference (TB-TA) and the temperature difference in the temperature difference function. In this graph, a line 431, a line 432, and a line 433 indicate the relationship between the temperature difference (TB-TA) and the temperature difference between the inner circumferential surface and the outer circumferential surface.

As indicated by the line 431, when the temperature difference (TB-TA) is 0° C. or lower, “SMALL” is set as the temperature difference between the inner circumferential surface and the outer circumferential surface.

As indicated by the line 432, when the temperature difference (TB-TA) is larger than 0° C. but not larger than 5° C., “MEDIUM” is set as the temperature difference between the inner circumferential surface and the outer circumferential surface.

Further, as indicated by the line 433, when the temperature difference (TB-TA) is larger than 5° C., “LARGE” is set as the temperature difference between the inner circumferential surface and the outer circumferential surface.

Since the temperature difference function is as described above, it is possible to determine a temperature difference in the fixing belt 52 from the temperature difference (TB-TA) between the temperature TB of the outer circumferential surface of the fixing belt 52 measured by the temperature sensor 59 and the temperature TA of the outer circumferential surface of the fixing belt 52 measured by the temperature sensor 58, using the temperature difference function.

### (3) Temperature Difference Detection Unit 113

The temperature difference detection unit 113 calculates the temperature difference (TB-TA) between the temperature TB of the outer circumferential surface of the fixing belt 52 measured by the temperature sensor 59, and the temperature TA of the outer circumferential surface of the fixing belt 52 measured by the temperature sensor 58.

The temperature difference detection unit 113 then reads the temperature difference corresponding to the calculated temperature difference (TB-TA) from the temperature difference table 141 stored in the storage unit 105, to acquire a temperature difference. The temperature difference detection unit 113 outputs the acquired temperature difference to the correction processing unit 112.

### (4) Operation of the First Modification

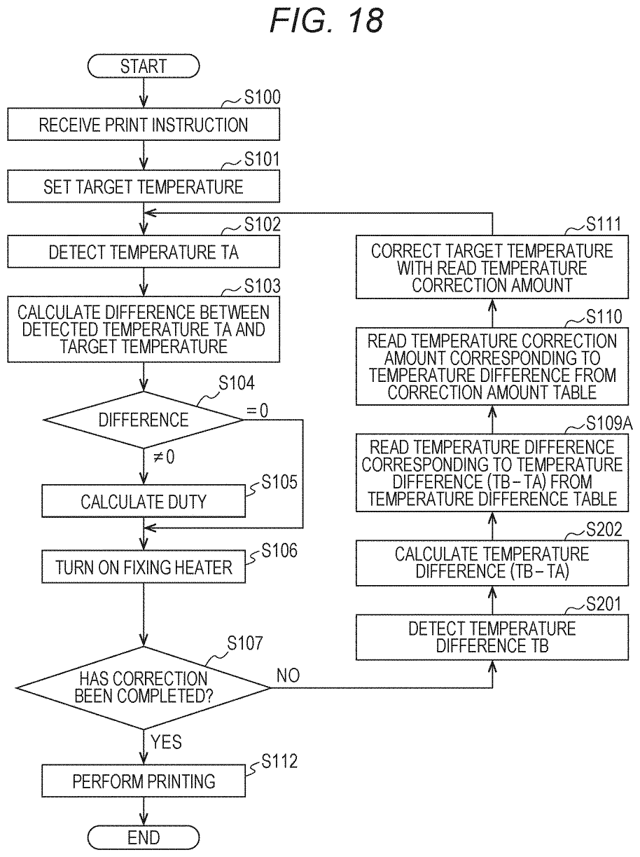

Operation of the first modification is now described with reference to the flowchart shown in FIG. 18.

Note that operation of the first modification is substantially the same as the operation of the embodiment shown in the flowchart in FIG. 13, and therefore, the description below will focus on the differences from the flowchart in FIG. 13.

The fixing device control unit 109 determines whether the temperature correction has been completed (step S107). If it is determined that the temperature correction has not been completed (“NO” in step S107), the temperature sensor 59 of the fixing unit 13 detects the temperature TB of the outer circumferential surface of the fixing belt 52. The heater control unit 111 receives the detected temperature TB from the temperature sensor 59 (step S201).

The temperature difference detection unit 113 then calculates the temperature difference (TB-TA) between the temperature TB of the outer circumferential surface of the fixing belt 52 detected by the temperature sensor 59, and the temperature TA of the outer circumferential surface of the fixing belt 52 measured by the temperature sensor 58 (step S202).

The temperature difference detection unit 113 then reads the temperature difference corresponding to the calculated temperature difference (TB-TA), from the temperature difference table 141 stored in the storage unit 105 (step S109A).

The fixing device control unit 109 then moves the control on to step S110.

The description of the differences between the operation of the first modification and the operation shown in the flowchart in FIG. 13 now comes to an end.

### (5) Summation

As described above, the temperature difference (TB-TA) between the temperature TB of the outer circumferential surface of the fixing belt 52 detected by the temperature sensor 59, and the temperature TA of the outer circumferential surface of the fixing belt 52 detected by the temperature sensor 58 is calculated. The temperature difference corresponding to the calculated temperature difference (TB-TA) is then read from the temperature difference table 141. The temperature correction amount corresponding to the temperature difference is then read from the correction amount table 131, the target temperature 140 is corrected with the read and received temperature correction amount, and the power supply to the fixing heater 54 is controlled so that the temperature detected to the temperature sensor 58 becomes equal to the corrected target temperature. As a result, the temperature at the position immediately before the fixing nip 57 becomes equal to the intended temperature, and it becomes possible to achieve an excellent effect to enable application of an appropriate amount of heat to a sheet, without any excess or deficiency of heat applied to the sheet.

### 3. Second Modification

A second modification that is a modification of the first modification is now described.

### (1) Fixing Unit 13B

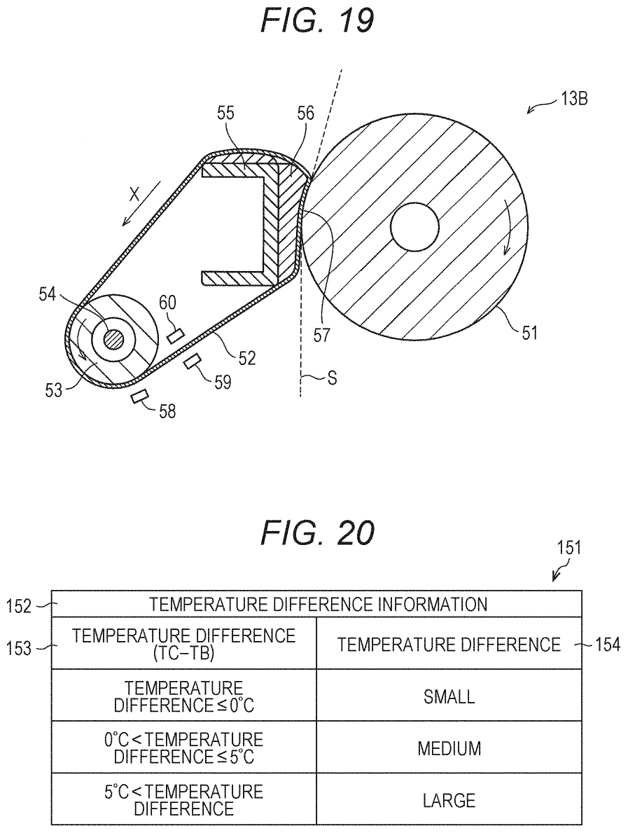

An image forming apparatus of the second modification includes a fixing unit 13B shown in FIG. 19, instead of the fixing unit 13A shown in FIG. 15. In the following, the description will focus on differences from the fixing unit 13A shown in FIG. 15.

The fixing unit 13B differs from the fixing unit 13A in that a temperature sensor 60 that detects the temperature of the inner circumferential surface of the fixing belt 52 is provided at a position facing the temperature sensor 59 via the fixing belt 52.

In this example, the temperature sensor 58, the temperature sensor 59, and the temperature sensor 60 are arranged at the same position in the axial direction (the longitudinal direction) of the fixing unit 13B.

### (2) Temperature Difference Table 151

The storage unit 105 stores a temperature difference table 151 shown in FIG. 20, instead of the temperature difference table 141 shown in FIG. 16.

As shown in FIG. 20, the temperature difference table 151 contains a plurality of pieces of temperature difference information. Each piece of temperature difference information includes a temperature difference and another temperature difference.

Here, the temperature difference in the fixing belt 52 is the temperature difference at the position where the temperature sensor 59 (60) is disposed in the revolving path of the fixing belt 52, for example.

Here, the temperature difference is the temperature difference (TC-TB) between the temperature TC of the inner circumferential surface of the fixing belt 52 to be detected by the temperature sensor 60, and the temperature TB of the outer circumferential surface of the fixing belt 52 to be detected by the temperature sensor 59. The temperature difference is a temperature difference in the fixing belt 52.

In the temperature difference information, when the temperature difference (TC-TB) is 0° C. or lower, “SMALL” indicating that the temperature difference is small is set as the temperature difference between the inner circumferential surface and the outer circumferential surface.

In the temperature difference information, when the temperature difference (TC-TB) is larger than 0° C. but not larger than 5° C., “MEDIUM” indicating that the temperature difference is moderate is set as the temperature difference between the inner circumferential surface and the outer circumferential surface.

Further, in the temperature difference information, when the temperature difference (TC-TB) is larger than 5° C., “LARGE” indicating that the temperature difference is large is set as the temperature difference between the inner circumferential surface and the outer circumferential surface.

Since the data structure of the temperature difference table 151 is as described above, it is possible to determine a temperature difference in the fixing belt 52 from the temperature difference (TC-TB) between the temperature TC of the inner circumferential surface of the fixing belt 52 measured by the temperature sensor 60 and the temperature TB of the outer circumferential surface of the fixing belt 52 measured by the temperature sensor 59, using the temperature difference table 151.

### Temperature Difference Function

The storage unit 105 may store a temperature difference function, instead of the temperature difference table 151 shown in FIG. 20.

The temperature difference function of the second modification outputs the temperature difference between the inner circumferential surface and the outer circumferential surface of the fixing belt 52, in accordance with the temperature difference (TC-TB) between the temperature TC of the inner circumferential surface of the fixing belt 52 to be detected by the temperature sensor 60, and the temperature TB of the outer circumferential surface of the fixing belt 52 to be detected by the temperature sensor 59.

A graph showing the temperature difference function of the second modification should be the same as the graph shown in FIG. 17. The graph of the second modification differs from the graph shown in FIG. 17 only in that the abscissa axis indicates the temperature difference (TC-TB) between the temperature TC of the inner circumferential surface of the fixing belt 52 measured by the temperature sensor 60, and the temperature TB of the outer circumferential surface of the fixing belt 52 measured by the temperature sensor 59.

### (3) Temperature Difference Detection Unit 113

The temperature difference detection unit 113 calculates the temperature difference (TC-TB) between the temperature TC of the inner circumferential surface of the fixing belt 52 measured by the temperature sensor 60, and the temperature TB of the outer circumferential surface of the fixing belt 52 measured by the temperature sensor 59.

The temperature difference detection unit 113 then reads the temperature difference corresponding to the calculated temperature difference (TC-TB) from the temperature difference table 151 stored in the storage unit 105, to acquire a temperature difference. The temperature difference detection unit 113 outputs the acquired temperature difference to the correction processing unit 112.

### (4) Operation of the Second Modification

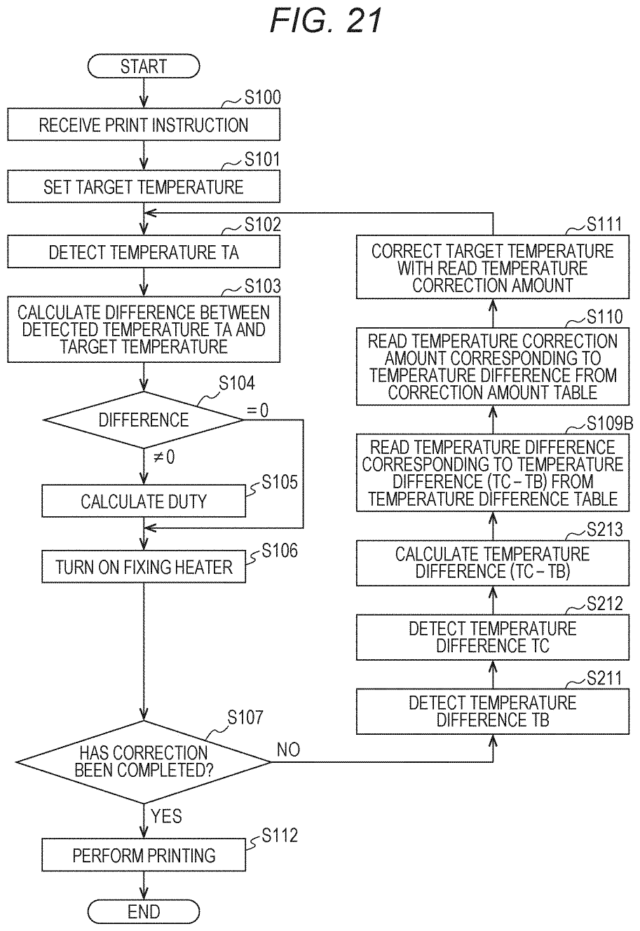

Operation of the second modification is now described with reference to the flowchart shown in FIG. 21.

Note that operation of the second modification is substantially the same as the operation of the first modification shown in the flowchart in FIG. 18, and therefore, the description below will focus on the differences from the flowchart in FIG. 18.

The fixing device control unit 109 determines whether the temperature correction has been completed (step S107). If it is determined that the temperature correction has not been completed (“NO” in step S107), the temperature sensor 59 of the fixing unit 13 detects the temperature TB of the outer circumferential surface of the fixing belt 52. The heater control unit 111 receives the detected temperature TB from the temperature sensor 59 (step S211).

The temperature sensor 60 of the fixing unit 13 then detects the temperature TC of the inner circumferential surface of the fixing belt 52. The heater control unit 111 receives the detected temperature TC from the temperature sensor 60 (step S212).

The temperature difference detection unit 113 then calculates the temperature difference (TC-TB) between the temperature TC of the inner circumferential surface of the fixing belt 52 detected by the temperature sensor 60, and the temperature TB of the outer circumferential surface of the fixing belt 52 measured by the temperature sensor 59 (step S213).

The temperature difference detection unit 113 then reads the temperature difference corresponding to the calculated temperature difference (TC-TB), from the temperature difference table 151 stored in the storage unit 105 (step S109B).

The fixing device control unit 109 then moves the control on to step S110.

The description of the differences between the operation of the second modification and the operation shown in the flowchart in FIG. 18 now comes to an end.

### (5) Summation

As described above, the temperature difference (TC-TB) between the temperature TC of the inner circumferential surface of the fixing belt 52 detected by the temperature sensor 60, and the temperature TB of the outer circumferential surface of the fixing belt 52 detected by the temperature sensor 59 is calculated. The temperature difference corresponding to the calculated temperature difference (TC-TB) is then read from the temperature difference table 151. The temperature correction amount corresponding to the temperature difference is then read from the correction amount table 131, the target temperature 140 is corrected with the read and received temperature correction amount, and the power supply to the fixing heater 54 is controlled so that the temperature detected to the temperature sensor 58 becomes equal to the corrected target temperature. As a result, the temperature at the position immediately before the fixing nip 57 becomes equal to the intended temperature, and it becomes possible to achieve an excellent effect to enable application of an appropriate amount of heat to a sheet, without any excess or deficiency of heat applied to the sheet.

### 4. Other Modifications

Although an embodiment of the present invention and modifications thereof have been described so far, the present invention is not limited to the above embodiment and modifications. The modifications described below may also be made.

(1) The image forming apparatus 10 may further include a scanner device. The scanner device reads a surface of a document, and generates image data. The print job may be a job for performing printing on the basis of the image data generated by the scanner device.

(2) In each of the fixing units 13, 13A, and 13B, a support roller may be used, instead of the fixing pad 56 and the support member 55. The support roller is formed by coating the circumferential surface of a cylindrical cored bar made of a metal such as aluminum with an elastic layer of rubber or the like, and further coating the circumferential surface of the elastic layer with a heat-resistant release layer. The pressure roller 51 presses the support roller via the fixing belt 52. As a result, the fixing nip 57, which is the contact region between the fixing belt 52 and the pressure roller 51, is formed.

In each of the fixing units 13, 13A, and 13B, the heating roller 53 that prevents the fixing heater 54 and the fixing belt 52 from coming into contact with each other may be in some other form, instead of the form of a roller. Alternatively, the heating roller 53 may not be provided, and the fixing heater 54 and the fixing belt 52 may be separated so as not to come into contact with each other. Further, it is possible to adopt a technique by which a fixing heater as the heat source is brought into contact with a fixing belt at a fixing nip, and heats the fixing belt directly.

(3) The image forming apparatus described above is a computer system including a microprocessor and a memory. The memory may store a computer program for control, and the microprocessor may operate in accordance with the computer program.

Here, the computer program is formed with a plurality of instruction codes indicating instructions directed to the computer to achieve predetermined functions.

The computer program may be recorded on a computer-readable recording medium, such as a flexible disk, a hard disk, an optical disk, or a semiconductor memory.

Alternatively, the computer program may be transmitted via a wired or wireless telecommunications line, a network such as by the Internet, data broadcasting, or the like.

(4) The above embodiment and each of the above modifications may be combined.

A fixing device according to an embodiment of the present invention has an excellent effect to enable application of an appropriate amount of heat to a sheet, and such an embodiment is useful as a technique for controlling the fixing temperature in a fixing device included in an electrophotographic image forming apparatus.

Although embodiments of the present invention have been described and illustrated in detail, the disclosed embodiments are made for purposes of illustration and example only and not limitation. The scope of the present invention should be interpreted by terms of the appended claims

What is claimed is:

1. A fixing device that thermally fixes a toner image formed on a sheet, the fixing device comprising:
an endless fixing belt;
a heat source that is disposed on an inner circumferential side of the fixing belt and is capable of adjusting an amount of heat generation with supplied electric power;
a pressure receiver disposed on the inner circumferential side of the fixing belt;
a pressure applier that presses the pressure receiver, to form a fixing nip with the fixing belt;
a temperature detector that detects a temperature of an outer circumferential surface of the fixing belt in the heat source;
a controller that controls power supply to the heat source, to adjust a detected temperature to be detected by the temperature detector to a target temperature;
a temperature difference detector that detects a temperature difference between an inner circumferential surface and the outer circumferential surface of the fixing belt; and
a corrector that corrects the target temperature of the controller, on a basis of the temperature difference detected by the temperature difference detector.

2. The fixing device according to claim 1, wherein
the controller cyclically repeats supply and shut-off of electric power to the heat source, in accordance with a turn-on ratio, and
detection of the temperature difference by the temperature difference detector is to estimate the temperature difference on a basis of the turn-on ratio used in the controller prior to correction of the target temperature by the corrector.

3. The fixing device according to claim 2, further comprising
a temperature difference table that stores a temperature difference between a temperature of the inner circumferential surface of the fixing belt and a temperature of the outer circumferential surface of the fixing belt in each cycle, the supply and shut-off of the electric power being taken as one cycle, the temperature difference being associated with the turn-on ratio indicating a ratio of a time of power supply to the heat source,
wherein the temperature difference detector reads the temperature difference corresponding to the determined turn-on ratio from the temperature difference table, to estimate the temperature difference.

4. The fixing device according to claim 2, further comprising
a temperature difference function that outputs a temperature difference between a temperature of the inner circumferential surface of the fixing belt and a temperature of the outer circumferential surface of the fixing belt in accordance with the turn-on ratio in each cycle, the supply and shut-off of the electric power being taken as one cycle, the turn-on ratio indicating a ratio of a time of power supply to the heat source,
wherein the temperature difference detector acquires the temperature difference corresponding to the determined turn-on ratio by using the temperature difference function, to estimate the temperature difference.

5. The fixing device according to claim 1, further comprising
a second temperature detector that detects a temperature of the outer circumferential surface of the fixing belt, at a position in a movement path of the fixing belt between a position of the temperature detector and a position immediately before the fixing nip,
wherein the temperature difference detector calculates a temperature difference between a second detected temperature detected by the second temperature detector and the detected temperature detected by the temperature detector, and performs estimation on a basis of the calculated temperature difference, to detect the temperature difference.

6. The fixing device according to claim 5, further comprising
a temperature difference table that stores a temperature difference between a temperature of the inner circumferential surface of the fixing belt and a temperature of the outer circumferential surface of the fixing belt, the temperature difference being associated with a temperature difference between the second detected temperature to be detected by the second temperature detector and the detected temperature to be detected by the temperature detector,
wherein the temperature difference detector reads the temperature difference corresponding to the calculated temperature difference from the temperature difference table, to estimate the temperature difference.

7. The fixing device according to claim 5, further comprising
a temperature difference function that outputs a temperature difference between a temperature of the inner circumferential surface of the fixing belt and a temperature of the outer circumferential surface of the fixing belt, in accordance with a temperature difference between the second detected temperature to be detected by the second temperature detector and the detected temperature to be detected by the temperature detector,
wherein the temperature difference detector acquires the temperature difference corresponding to the calculated temperature difference by using the temperature difference function, to estimate the temperature difference.

8. The fixing device according to claim 1, further comprising:
a second temperature detector that detects a temperature of the outer circumferential surface of the fixing belt, at a position in a movement path of the fixing belt between a position of the temperature detector and a position immediately before the fixing nip; and
a third temperature detector that detects a temperature of the inner circumferential surface of the fixing belt, at a position facing the second temperature detector via the fixing belt,
wherein the temperature difference detector calculates a temperature difference between a third detected temperature detected by the third temperature detector and a second detected temperature detected by the second temperature detector, and detects the temperature difference on a basis of the calculated temperature difference.

9. The fixing device according to claim 8, further comprising
a temperature difference table that stores a temperature difference between a temperature of the inner circumferential surface of the fixing belt and a temperature of the outer circumferential surface of the fixing belt, the temperature difference being associated with a temperature difference between the third detected temperature to be detected by the third temperature detector and the second detected temperature to be detected by the second temperature detector,
wherein the temperature difference detector reads the temperature difference corresponding to the calculated temperature difference from the temperature difference table, to detect the temperature difference.

10. The fixing device according to claim 8, further comprising
a temperature difference function that outputs a temperature difference between a temperature of the inner circumferential surface of the fixing belt and a temperature of the outer circumferential surface of the fixing belt, in accordance with a temperature difference between the third detected temperature to be detected by the third temperature detector and the second detected temperature to be detected by the second temperature detector,
wherein the temperature difference detector acquires the temperature difference corresponding to the calculated temperature difference by using the temperature difference function, to detect the temperature difference.

11. The fixing device according to claim 1, wherein
the corrector has a correction amount table that stores a temperature correction amount for the target temperature, the temperature correction amount being associated with a temperature difference between a temperature of the inner circumferential surface of the fixing belt and a temperature of the outer circumferential surface of the fixing belt, and
the corrector reads the temperature correction amount corresponding to the detected temperature difference from the correction amount table, and corrects the target temperature with the read temperature correction amount.

12. The fixing device according to claim 1, wherein
the corrector has a correction function that outputs a temperature correction amount for the target temperature, the temperature correction amount being associated with a temperature difference between a temperature of the inner circumferential surface of the fixing belt and a temperature of the outer circumferential surface of the fixing belt, and
the corrector acquires the temperature correction amount corresponding to the detected temperature difference by using the correction function, and corrects the target temperature with the acquired temperature correction amount.

13. An image forming apparatus that forms an image by an electrophotographic technique,
the image forming apparatus comprising
the fixing device according to claim 1.

14. A control method implemented in a fixing device that thermally fixes a toner image formed on a sheet,
the fixing device including: an endless fixing belt; a heat source that is disposed on an inner circumferential side of the fixing belt and is capable of adjusting an amount of heat generation with supplied electric power; a pressure receiver disposed on the inner circumferential side of the fixing belt; a pressure applier that presses the pressure receiver, to form a fixing nip with the fixing belt; and a temperature detector that detects a temperature of an outer circumferential surface of the fixing belt in the heat source,
the control method comprising:
controlling power supply to the heat source, to adjust a detected temperature to be detected by the temperature detector to a target temperature;
detecting a temperature difference between an inner circumferential surface and the outer circumferential surface of the fixing belt; and
correcting the target temperature, on a basis of the detected temperature difference.

15. A non-transitory recording medium storing a computer readable program for control in a fixing device that thermally fixes a toner image formed on a sheet,
the fixing device including: an endless fixing belt; a heat source that is disposed on an inner circumferential side of the fixing belt and is capable of adjusting an amount of heat generation with supplied electric power; a pressure receiver disposed on the inner circumferential side of the fixing belt; a pressure applier that presses the pressure receiver, to form a fixing nip with the fixing belt; and a temperature detector that detects a temperature of an outer circumferential surface of the fixing belt in the heat source,
the fixing device being a computer,
the computer-readable program causing the fixing device to perform:
controlling power supply to the heat source, to adjust a detected temperature to be detected by the temperature detector to a target temperature;
detecting a temperature difference between an inner circumferential surface and the outer circumferential surface of the fixing belt; and
correcting the target temperature, on a basis of the detected temperature difference.
